(19) United States
(12) Patent Application Publication
(10) Pub. No.: US 2025/0063345 A1
(43) Pub. Date: Feb. 20, 2025

(54) METHOD FOR REPLACING A WIRELESS COMMUNICATIONS MODULE IN AN APPLIANCE

(71) Applicant: Haier US Appliance Solutions, Inc., Wilmington, DE (US)

(72) Inventor: Haitian Hu, Louisville, KY (US)

(21) Appl. No.: 18/450,170

(22) Filed: Aug. 15, 2023

(51) Int. Cl. H04W 12/03; H04W 12/73; H04W 76/10

(52) U.S. Cl. CPC H04W 12/03; H04W 12/73; H04W 76/10

(57) ABSTRACT

A method for replacing an old wireless communications module of an appliance with a new wireless communications module includes detecting installation of the new wireless communications module in the appliance connected to a local network, obtaining encrypted data comprising a wireless network identifier and a wireless network password of the local network, decrypting the encrypted data to determine the wireless network identifier and the wireless network password, and establishing connection with a remote server through the local network using the wireless network identifier and the wireless network password.

### FIELD OF THE INVENTION

The present subject matter relates generally to network-connected appliances, and more particularly to methods for replacing wireless communications modules in connected appliances.

### BACKGROUND OF THE INVENTION

Appliances commonly include wireless communications modules, e.g., Wi-Fi modules, that facilitate communication between the appliance and a remote network. These connected appliances may benefit from performance enhancing updates, remote diagnostics, improved user interaction through software applications, and other benefits of being connected to the remote server.

However, when a Wi-Fi module stops working or otherwise needs to be replaced, a compatible module must physically replace the old module. Notably, simply swapping out the Wi-Fi modules may not result in an operable module and may not connect to the network. For example, an appliance owner or technician must typically perform a time-consuming cloud connection process to restore the appliance's cloud connection through the new Wi-Fi modules. In this regard, each Wi-Fi module may have a unique network identifier or address, often referred to as a media access control identifier (MAC ID). Accordingly, when the new Wi-Fi module is reconnected to the network, it has a different MAC ID and the appliance's historical operating data associated with the old Wi-Fi module is not linked to the new Wi-Fi module. In addition, a user must manually enter the local network name and password.

Accordingly, an improved method of replacing a wireless communications module in an appliance is desired. More specifically, a method of installing a new Wi-Fi module in an appliance while linking appliance operating data in a seamless and user-friendly manner would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a method for replacing an old wireless communications module of an appliance with a new wireless communications module is provided. The method includes detecting installation of the new wireless communications module in the appliance connected to a local network, obtaining encrypted data comprising a wireless network identifier and a wireless network password of the local network, decrypting the encrypted data to determine the wireless network identifier and the wireless network password, and establishing connection with a remote server through the local network using the wireless network identifier and the wireless network password.

In another exemplary embodiment, a wireless communications module for an appliance is provided. The wireless communications module is configured to detect installation of the wireless communications module in the appliance connected to a local network, obtain encrypted data comprising a wireless network identifier and a wireless network password of the local network, decrypt the encrypted data to determine the wireless network identifier and the wireless network password, and establish connection with a remote server through the local network using the wireless network identifier and the wireless network password.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a plurality of appliances connected to a remote server through an external network according to an example embodiment of the present subject matter.

FIG. 2 provides a schematic view of a system for replacing a wireless communications module in an appliance according to an example embodiment of the present subject matter.

FIG. 3 provides another schematic view of a system for replacing a wireless communications module in an appliance according to an example embodiment of the present subject matter.

FIG. 4 illustrates a method for replacing a wireless communications module in an appliance according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

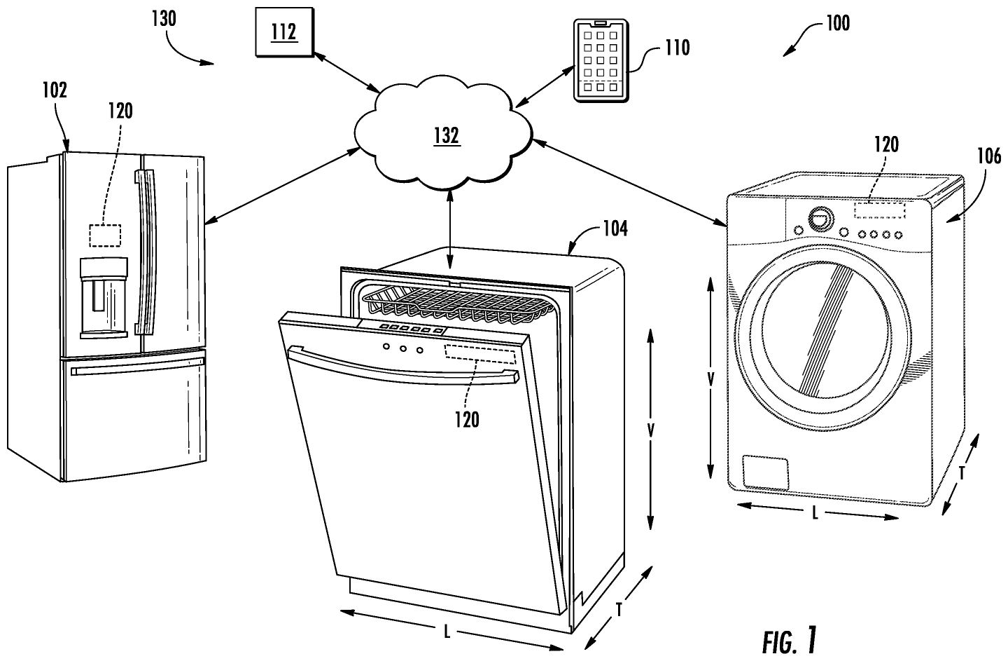

Referring now to FIG. 1, a system of appliances 100 will be described according to exemplary embodiments of the present subject matter. In general, system of appliances 100 may include any suitable number, type, and configuration of appliances, remote servers, network devices, and/or other external devices. Some of these appliances 100 may be able to communicate with each other or are otherwise interconnected. This interconnection, interlinking, and interoperability of multiple appliances and/or devices may commonly be referred to as “smart home” or “connected home” appliance interconnectivity.

FIG. 1 illustrates system of appliances 100 according to exemplary embodiments of the present subject matter. As shown, system of appliances 100 generally includes a first appliance 102 (e.g., illustrated herein as a refrigerator appliance), a second appliance 104 (e.g., illustrated herein as a dishwasher), and a third appliance 106 (e.g., illustrated herein as a washing machine). Details regarding the operation of first appliance 102, second appliance 104, and third appliance 106 may be understood by one having ordinary skill in the art and detailed discussion is omitted herein for brevity. However, it should be appreciated that the specific appliance types and configurations are only exemplary and are provided to facilitate discussion regarding the use and operation of an exemplary system of appliances 100. The scope of the present subject matter is not limited to the number, type, and configurations of appliances set forth herein.

For example, the system of appliances 100 may include any suitable number and type of “appliances,” such as “household appliances.” These terms are used herein to describe appliances typically used or intended for common domestic tasks, e.g., such as the appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions. Moreover, although only three appliances are illustrated, various embodiments of the present subject matter may also include another number of appliances, each of which may generate and store data.

In addition, it should be appreciated that system of appliances 100 may include one or more external devices, e.g., devices that are separate from or external to the one or more appliances, and which may be configured for facilitating communications with various appliances or other devices. For example, according to exemplary embodiments of the present subject matter, the system of appliances 100 may include or be communicatively coupled with a remote user interface device 110 that may be configured to enable user interaction with some or all appliances or other devices in the system of appliances 100.

In general, remote user interface device 110 may be any suitable device separate and apart from appliances (e.g., such as first appliance 102, second appliance 104, and third appliance 106) that is configured to provide and/or receive communications, information, data, or commands from a user. In this regard, remote user interface device 110 may be an additional user interface to the user interface panels of the various appliances within the system of appliances 100. In this regard, for example, the user interface device 110 may be a personal phone, a smartphone, a tablet, a laptop or personal computer, a wearable device, a smart home system, or another mobile or remote device. For example, the separate device may be a smartphone operable to store and run applications, also known as “apps,” and the remote user interface device 110 be provided as a smartphone app.

In addition, as will be described in more detail below, some or all of the system of appliances 100 may include or be communicatively coupled with a remote server 112 that may be in operative communication with remote user interface device 110 and/or some or all appliances within system of appliances 100. Thus, user interface device 110 and/or remote server 112 may refer to one or more devices that are not considered household appliances as used herein. In addition, devices such as a personal computer, router, network devices, and other similar devices whose primary functions are network communication and/or data processing are not considered household appliances as used herein.

As illustrated, each of first appliance 102, second appliance 104, third appliance 106, remote user interface device 110, or any other devices or appliances in system of appliances 100 may include or be operably coupled to a controller, identified herein generally by reference numeral 120. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable communication module, communication lines, or network(s).

Referring still to FIG. 1, a schematic diagram of an external communication system 130 will be described according to an exemplary embodiment of the present subject matter. In general, external communication system 130 is configured for permitting interaction, data transfer, and other communications between and among first appliance 102, second appliance 104, third appliance 106, remote user interface device 110, remote server 112, other appliances within system of appliances 100, and/or one or more external devices. For example, this communication may be used to provide and receive operating parameters, cycle settings, user instructions or notifications, performance characteristics, user preferences, or any other suitable information for improved performance of one or more appliances within system of appliances 100. In addition, it should be appreciated that external communication system 130 may be used to transfer data or other information to improve performance of one or more external devices or appliances and/or improve user interaction with such devices.

In addition, remote server 112 may be in communication with an appliance and/or remote user interface device 110 through a network 132. In this regard, for example, remote server 112 may be a cloud-based server 112, and is thus located at a distant location, such as in a separate state, country, etc. According to an exemplary embodiment, remote user interface device 110 may communicate with a remote server 112 over network 132, such as the Internet, to transmit/receive data or information, provide user inputs, receive user notifications or instructions, interact with or control the appliance, etc. In addition, remote user interface device 110 and remote server 112 may communicate with the appliance to communicate similar information.

In general, communication between an appliance, remote user interface device 110, remote server 112, and/or other user devices or appliances may be carried using any type of wired or wireless connection and using any suitable type of communication network, non-limiting examples of which are provided below. For example, remote user interface device 110 may be in direct or indirect communication with the appliance through any suitable wired or wireless communication connections or interfaces, such as network 132. For example, network 132 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP. HTTP, SMTP, FTP), encodings or formats (e.g., HTML, XML), and/or protection schemes (e.g., VPN, secure HTTP, SSL).

External communication system 130 is described herein according to an exemplary embodiment of the present subject matter. However, it should be appreciated that the exemplary functions and configurations of external communication system 130 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

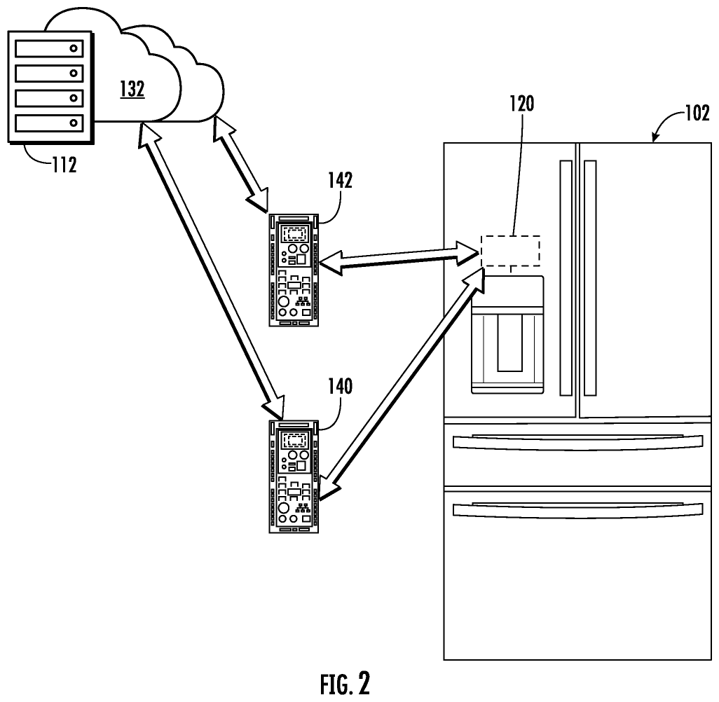

Referring now briefly to FIG. 2, refrigerator appliance 102 is illustrated, specifically, to schematically illustrate and describe the process of replacing wireless communications modules (e.g., Wi-Fi modules) in an appliance. For example, these wireless communications modules may need to be replaced periodically due to component failure or other module operational issues. However, connecting a conventional Wi-Fi module is a complex, time-consuming process that burdens the consumer, generates user dissatisfaction, and disrupts appliance operation. Accordingly, aspects of the present subject matter are directed to a system and method for facilitating Wi-Fi module replacement with minimal user intervention in any connected appliance.

For example, as illustrated, refrigerator appliance 102 includes an old wireless communications module 140 that is faulty and needs to be replaced. Accordingly, the user or a maintenance technician may disconnect and remove the old wireless communications module 140 and may connect a new wireless communications module 142 in its place. Notably, however, the new wireless communications module 142 does not automatically connect to the local network such that it may communicate with remote server 112. In addition, prior appliance usage data or historical board/appliance information related to the old wireless communications module 140 is not transferred over to the new wireless communications module 142, but this information may be important for seamless operation of refrigerator appliance 102 and continued interaction with remote server 112. Aspects of the present subject matter address these and other issues related to Wi-Fi module replacement.

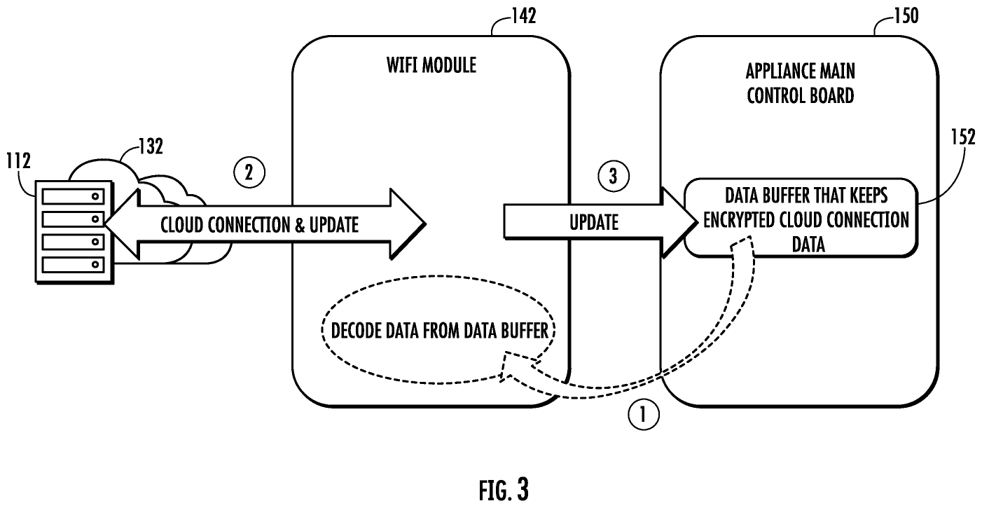

Referring now to FIG. 3, each appliance 102-106 of system of appliances 100 may generally include a main control board 150, e.g., which may be housed on controller 120 of their respective appliances 102-106. According to still other embodiments, main control board 150 may be a discrete board located at any suitable location within the respective appliances 102-106 and may be operably coupled through one or more communication channels. As illustrated, main control board 150 may generally include a data buffer 152 that stores encrypted cloud connection data as well as other operating information related to the respective appliance 102-106. As shown, main control board 150 may interface with a wireless communication module, such as old wireless communications module 140 and/or new wireless communications module 142, e.g., to facilitate network connectivity and communications with remote server 112.

Now that the construction of system of appliances 100 and external communication system 130 have been presented according to exemplary embodiments, an exemplary method 200 of replacing a wireless communications module of an appliance will be described. Although the discussion below refers to the exemplary method 200 of performing replacing a wireless communications module in refrigerator appliance 102, one skilled in the art will appreciate that the exemplary method 200 is applicable to any other suitable number, type, and configuration of appliances. In exemplary embodiments, the various method steps as disclosed herein may be performed by the wireless control module, remote server 112, one or more controllers (e.g., such as controllers 120) or by a separate, dedicated controller that may be located locally on one or more of the appliances, remotely on a remote server, etc.

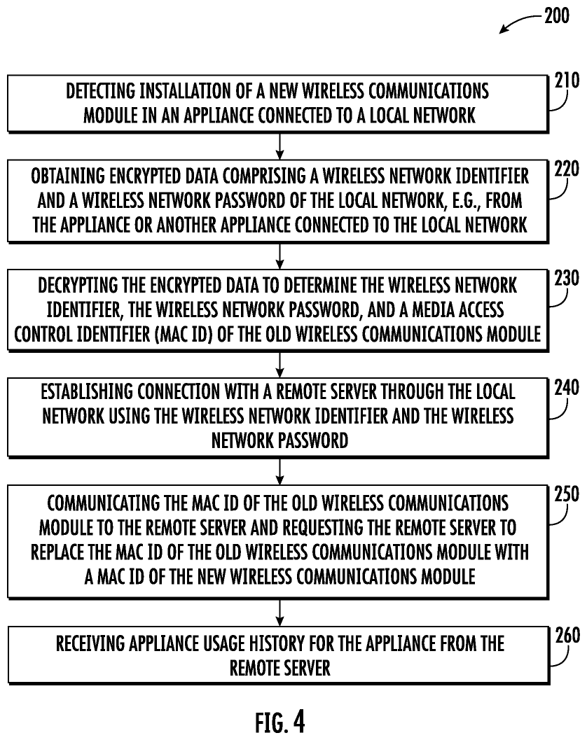

Specifically, as shown in FIG. 4, method 200 includes, at step 210, detecting installation of a new wireless communications module in an appliance connected to a local network. In this regard, continuing the example from above, refrigerator appliance 102 may be within a system of appliances 100 connected on a single home Wi-Fi network or in another local environment. These appliances may communicate directly with each other and/or remote server 112, e.g., through network 132, through a local Wi-Fi network, through Bluetooth communications, etc. According to example embodiments, when the old wireless communications module 140 is removed and new wireless communications module 142 is installed, new wireless communications module 142 may be configured for performing method 200 to facilitate Wi-Fi module replacement. In this manner, step 210 may include detecting, at new wireless communication module 142, a new external connection, e.g., to main control board 150 of refrigerator appliance 102.

Step 220 may generally include obtaining encrypted data comprising at least one of a wireless network identifier of a local network, a wireless network password of the local network, and/or a media access control identifier (MAC ID) of the old wireless communications module. According to example embodiments, the wireless network identifier is a service set identifier (SSID). Notably, according to an example embodiment, this encrypted data is received directly from main control board 150 of refrigerator appliance 102. However, it should be appreciated that according to alternative embodiments, the encrypted data may be obtained from any other appliance located within system of appliances 100, or any other appliance connected to the local network or in the same ecosystem as refrigerator appliance 102. In this regard, network access information may be stored in any or all of appliances 102-106, and new wireless communications module 142 may communicate with any of these appliances to obtain this encrypted information.

Notably, new wireless communications module 152 may be particularly suited for decrypting the encrypted data received at step 220. In this regard, new wireless communications module 152 may be programmed with the encryption protocol and the encryption keys necessary to decrypt the data. Notably, this decryption may be performed automatically and without user intervention. Specifically, step 230 includes decrypting the encrypted data to determine the wireless network identifier, the wireless network password, and/or the MAC ID of the old wireless communications module.

Step 240 may generally include establishing a connection with a remote server through the local network using a wireless network identifier and the wireless network password. In this regard, upon installation of new wireless communications module 142, this module may communicate with remote server 112 through network 132, e.g., by providing authentication credentials, e.g., such as the wireless network identifier and the wireless network password. Notably, new wireless communications module 142 may have a unique MAC ID relative to old wireless communications module 140. Accordingly, it may be desirable to inform remote server 112 of the module replacement in order to seamlessly synchronize and update appliance and module data.

Accordingly, step 250 may generally include communicating the MAC ID of the old wireless communications module to the remote server. In this regard, the new wireless communications module 142 may generally communicate with remote server 112 to indicate that old wireless communications module 140 (e.g., identified using an old MAC ID) is being replaced with new wireless communications module 142 (e.g., identified using a new MAC ID). In this manner, remote server 112 may know that communications received from new wireless communications module 142 may be associated with the same appliance (e.g., refrigerator appliance 102) as were the communications with old wireless communications module 140.

In addition, step 260 may include receiving appliance usage history for the appliance from the remote server. In this regard, after new wireless communications module 142 has indicated that it is the replacement for old wireless communications module 140, remote server may synchronize data associated with the old wireless communications module 140. This may include, for example, operating data related to refrigerator appliance 100, data related to old wireless communications module 140, etc. This appliance usage history may include any other suitable data that facilitates improved interaction between refrigerator appliance 102 and remote server 112.

In addition, new wireless communications module 142 may communicate at least one of a manufacturing date, a software version, or board settings of the new wireless communication module 142. Upon transmitting this information, remote server 112 may verify that new wireless communications module 142 is running the appropriate software or is a compatible piece of hardware for communicating and interfacing between refrigerator appliance 102 and remote server 112. According to example embodiments, method 200 may include determining that the software version is not the latest software version in initiating an update of new wireless communication module 142 to the latest software version.

Notably, it may also be desirable to communicate necessary information to main control board 150 related to the replacement of the wireless communication module. Accordingly, method 200 may further include encrypting the MAC ID of the new wireless communication module and sending the encrypted MAC ID to the main control board of the appliance. In this manner, data buffer 152 of main control board 150 may include encrypted network identifier, network password, and MAC ID of the current Wi-Fi module for future use.

It may be periodically necessary to replace the main control board 150 of refrigerator appliance 102. Accordingly, method 200 may further include determining that an old main control board of the appliance has been replaced with a new main control board. Notably, the new main control board will not include the same encrypted data discussed in the prior paragraph. Accordingly, method 200 may further include initializing the new main control board with the encrypted data from the current wireless communication module, e.g., new wireless communications module 142.

FIG. 4 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using appliances 102-106 and remote server 112 as an example, it should be appreciated that these methods may be applied to the installation of a new wireless communications module in any suitable appliance.

As explained herein, aspects of the present subject matter are generally directed to a system and method for automatically connecting a replaced appliance Wi-Fi module to the cloud without human involvement. The main control board within an appliance may contain a data buffer designed to store an encrypted copy of the appliance's Wi-Fi module and local Wi-Fi network credentials, including the Wi-Fi module's MAC ID, network SSID, and password. When a new Wi-Fi module is installed, the module may retrieve the encrypted data from the buffer, decrypt the data, establish a connection to the cloud without any human intervention, send a request to set a link between the old MAC ID and the new one, and update the data buffer with the new encrypted data. Once the new Wi-Fi module is connected, it may request an in-cloud process to link the appliance's usage history pre and post the Wi-Fi module replacement, by providing both its own and the old module's credentials.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for replacing an old wireless communications module of an appliance with a new wireless communications module, the method comprising:
detecting installation of the new wireless communications module in the appliance connected to a local network;
obtaining encrypted data comprising a wireless network identifier and a wireless network password of the local network;
decrypting the encrypted data to determine the wireless network identifier and the wireless network password; and
establishing connection with a remote server through the local network using the wireless network identifier and the wireless network password.

2. The method of claim 1, wherein the encrypted data is obtained from a main control board of the appliance.

3. The method of claim 1, wherein the appliance is a first appliance of a plurality of appliances connected to the local network, and wherein the encrypted data is obtained from a second appliance of the plurality of appliances.

4. The method of claim 1, wherein the encrypted data comprises a media access control identifier (MAC ID) of the old wireless communications module, the method further comprising:
decrypting the encrypted data to determine the MAC ID of the old wireless communications module;
communicating the MAC ID of the old wireless communications module to the remote server; and
receiving appliance usage history for the appliance from the remote server.

5. The method of claim 4, further comprising:
sending a request to the remote server to replace the MAC ID of the old wireless communications module with a MAC ID of the new wireless communications module.

6. The method of claim 5, further comprising:
encrypting the MAC ID of the new wireless communications module; and
sending the encrypted MAC ID to a main control board of the appliance.

7. The method of claim 1, wherein the wireless network identifier is a service set identifier (SSID).

8. The method of claim 1, further comprising:
determining that an old main control board of the appliance has been replaced with a new main control board; and
initializing the new main control board with encrypted data from a current wireless communications module.

9. The method of claim 1, wherein the encrypted data further comprises at least one of manufacturing date, software version, or board settings of the wireless communications module.

10. The method of claim 9, further comprising:
determining that the software version is not a latest software version; and
initiating an update of the new wireless communications module to the latest software version.

11. A wireless communications module for an appliance, the wireless communications module being configured to:
detect installation of the wireless communications module in the appliance connected to a local network;
obtain encrypted data comprising a wireless network identifier and a wireless network password of the local network;
decrypt the encrypted data to determine the wireless network identifier and the wireless network password; and
establish connection with a remote server through the local network using the wireless network identifier and the wireless network password.

12. The wireless communications module of claim 11, wherein the encrypted data is obtained from a main control board of the appliance.

13. The wireless communications module of claim 11, wherein the appliance is a first appliance of a plurality of appliances connected to the local network, and wherein the encrypted data is obtained from a second appliance of the plurality of appliances.

14. The wireless communications module of claim 11, wherein the encrypted data comprises a media access control identifier (MAC ID) of an old wireless communications module, the wireless communications module being further configured to:
decrypt the encrypted data to determine the MAC ID of the old wireless communications module;
communicate the MAC ID of the old wireless communications module to the remote server; and
receive appliance usage history for the appliance from the remote server.

15. The wireless communications module of claim 14, wherein the wireless communications module is further configured to:
send a request to the remote server to replace the MAC ID of the old wireless communications module with a MAC ID of the wireless communications module.

16. The wireless communications module of claim 15, wherein the wireless communications module is further configured to:
encrypt the MAC ID of the wireless communications module; and
send the encrypted MAC ID to a main control board of the appliance.

17. The wireless communications module of claim 11, wherein the wireless network identifier is a service set identifier (SSID).

18. The wireless communications module of claim 11, wherein the wireless communications module is further configured to:
determine that an old main control board of the appliance has been replaced with a new main control board; and
initialize the new main control board with encrypted data from a current wireless communications module.

19. The wireless communications module of claim 11, wherein the encrypted data further comprises at least one of manufacturing date, software version, or board settings of the wireless communications module.

20. The wireless communications module of claim 19, wherein the wireless communications module is further configured to:
determine that the software version is not a latest software version; and
initiate an update of the wireless communications module to the latest software version.
